(19) United States
(12) Patent Application Publication
(10) Pub. No.: US 2011/0077947 A1
(43) Pub. Date: Mar. 31, 2011

(54) CONFERENCE BRIDGE SOFTWARE AGENTS

(75) Inventors: Derek Beauregard, Denver, CO (US); Vivek Bhatnagar, Federal Heights, CO (US); Praveen K. Mamnani, Westminster, CO (US)

(73) Assignee: Avaya, Inc., Basking Ridge, NJ (US)

(21) Appl. No.: 12/571,206

(22) Filed: Sep. 30, 2009

(51) Int. Cl. G10L 15/00; G06F 15/16; H04L 12/16

(52) U.S. Cl. 704/275; 709/204; 370/260; 704/E15.001

(57) ABSTRACT

Systems and methods are provided to generate a software agent that is initiated to continue the business process flow during a conference. Upon initiating a teleconference in response to a selection associated with the business process or predefined rule associated with the business process that requires a conference, an instance of a software agent is instantiated and associated with the teleconference. The software agent may be a sub-process of the conference bridge that conducts the teleconference or a separate process that interacts with the conference bridge as another party to the teleconference. The software agent is initiated with information about the business process step that requires an action or a decision. During the teleconference, the software agent listens for a command from one of the parties and acts on any command given. The commands can send another event or action back to a business process application to continue or complete the business process. The event or action sent back may be based on the commands or a result of an action on the business process step that initiate the conference.

### BACKGROUND

Business and other organizations have come to use communication-enable business processes to make decisions within the business. As such, when something needs to be accomplished, an entity creates a business process in a business process application. The business process application tracks and manages the business process to completion. However, when deciding to act on a part of the business process, a user may decide to conference with another party. The conference can be provided as an option of the requirement provided by the business process application. However, once involved in the conference, there is generally no method for affecting actions and passing context information in the conference to and from the business process. Rather, the business process application views the conference as a step completing the business process, which may be incorrect. Thus, generally any similarly structured business process would split the business process into discreet sub-processes. One sub-process would complete actions before the conference and a second sub-process would complete the actions after the conference. The completion of the first sub-process and the creation of the second sub-process require manual human intervention.

### SUMMARY

It is with respect to the above issues and other problems that the embodiments presented herein were contemplated. Herein, systems and methods provide a software agent that is initiated to continue the business process flow during a conference. In embodiments, upon initiating a conference, an instance of a software agent is instantiated and associated with the conference. The software agent may be a sub-process of the conference bridge that conducts the conference or a separate process or service that interacts with the conference bridge as another party to the conference. The software agent is initiated with information about the business process step that requires information or a decision. During the conference, the software agent listens for a command from one of the parties and acts on any command given. The commands can send another action back to a business process application to continue or complete the business process.

Exemplary applications for the embodiments include supporting any type of business process application that allows conferencing. The software agent can interact with the business process and the conference bridge by using application programming interfaces. Thus, the software agent is agnostic to the type of business process application. Further, the software agent can be an interactive voice response (IVR) application such that the IVR application appears to the conference bridge as another “human” participant.

The embodiments can have a number of advantages. For example, the software agent can allow users to discuss important decisions before inputting a decision into the business process. As such, the business process need not view a conference as a final completion but another step in the business process.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including, but not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures:

FIG. 1 is a block diagram of an embodiment of a system for extending a business process to a conference bridge;

FIG. 2 is a block diagram of an embodiment of a software agent operable to interact with the business process and with the conference bridge;

FIGS. 3A-3C are block diagrams of embodiments of data structures that are stored, sent, or received by one or more computer systems when integrating a business process with the software agent;

FIG. 4 is a flow diagram of an embodiment of a process for integrating a business process with a software agent;

FIG. 5 is a flow diagram of an embodiment of a process for providing a software agent to interact with the user(s) during a conference to continue a business process;

FIG. 6 is a block diagram of an embodiment of a computer system environment in which the systems and methods may be executed; and

FIG. 7 is a block diagram of a computer system in which the systems and methods may be executed.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the invention. Rather, the ensuing description will provide those skilled in the art with an enabling description for implementing the embodiments. It should be understood that various changes may be made in the function and arrangement of elements without departing from the spirit and scope of the invention as set forth in the appended claims.

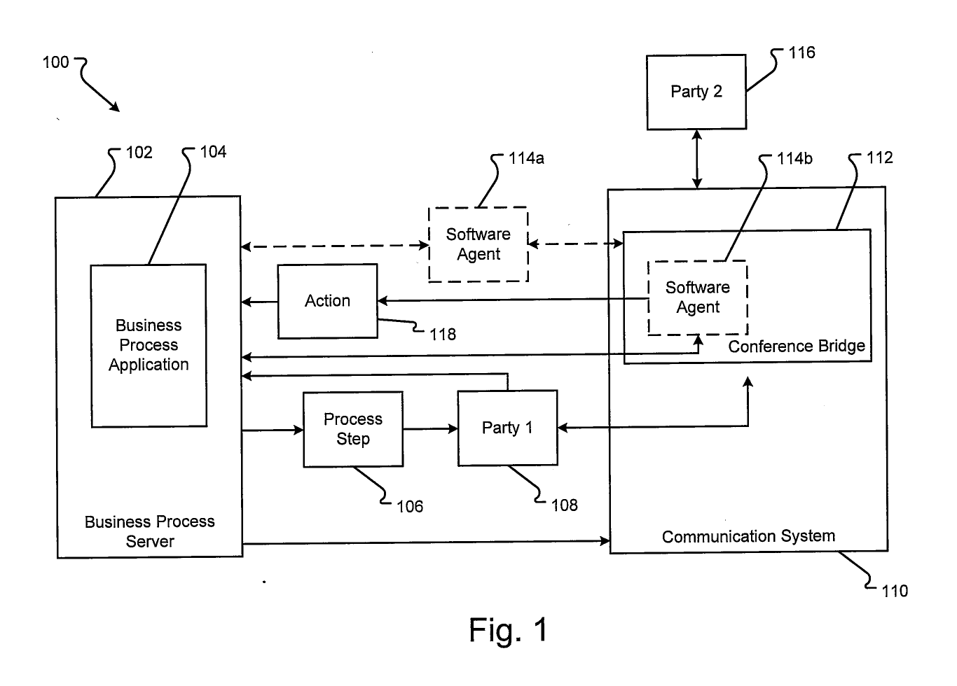

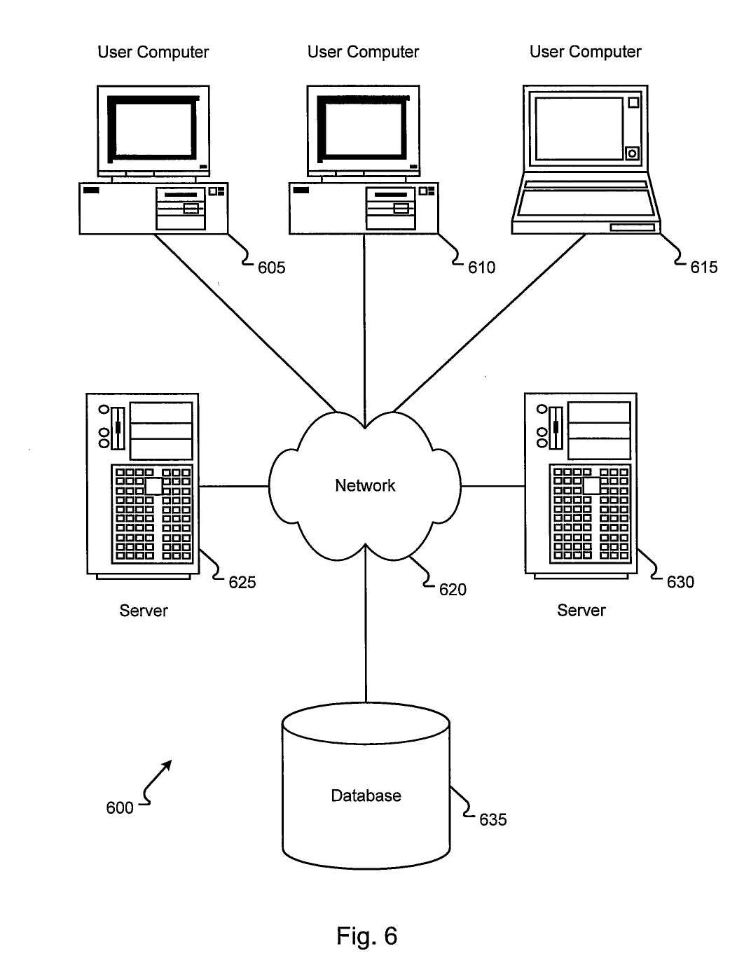

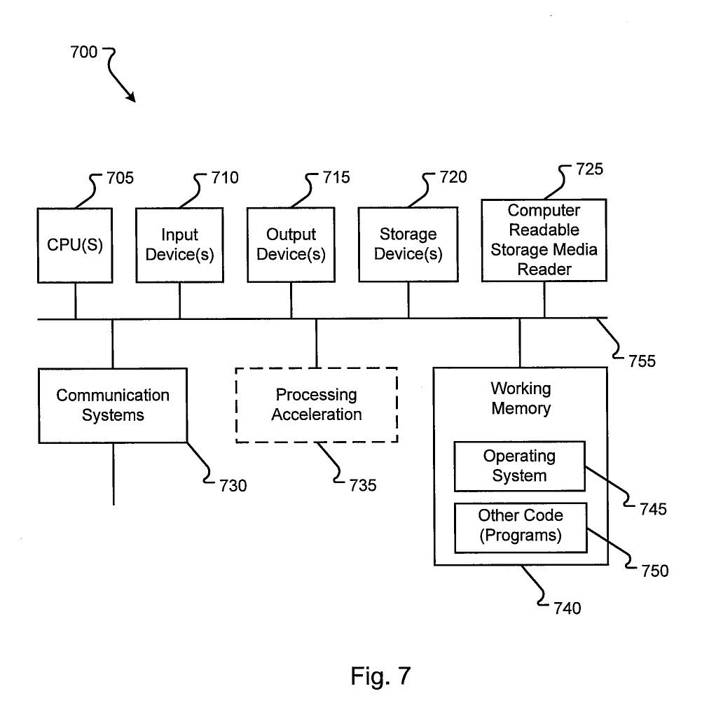

An embodiment of a system 100 operable to integrate a business process with a software agent is shown in FIG. 1. The several components of the system 100 may be hardware, software, or a combination of hardware and software. Descriptions of the computer system environment and the computer systems which may embody the several components of system 100 are described in conjunction with FIGS. 6 and 7. However, it should be noted that the software applications or one or more of the computing systems may be embodied in specially designed hardware, for example, an application specific integrated circuit (ASIC), a field programmable gate array (FPGA), etc.

In embodiments, a business process server 102 is a computing system that can execute a business process application 104. The business process application 104 can represent any application, such as a specially-designed application, written in any software programming language. The business process server 102 may include one or more of the components described in FIGS. 6 and 7. In embodiments, the business process server 102 may be geographically separated from the user or the communication system 110 and operate for an entire entity. The business process application 104 is any software package operable to receive business process inputs, manage business processes, and initiate or complete actions for users associated with the business process. A business process can be any action or process conducted by an entity in the entity's operations. Examples of business processes can include submissions to governmental organizations, project planning efforts, product ordering, etc. Examples of business process applications can include NetWeaver™ offered by SAP or BPM+ offered by Tibco. While examples are given, it should be noted that the business process can be any business function that collects data and acts on behalf of humans. Further, the business process server can represent any business process application that may be, but is not limited to, a business process execution language (BPEL) compliant application written in a software programming language.

The business process application 104 can generate an action or process step 106 for a user. The process step 106 can be a directive to a person in the organization to complete some action. For example, the process step 106 could be a request to approve the hiring of a new employee or the approval of a purchase order. The process step 106 is sent to a user, party 1 108. To send the process step 106, the business process server 102 can send an email or have a directive queued for the user when the user interfaces with the business process application 104. Regardless, one of the options for the user may be to initiate a conference call with one or more other individuals to discuss the process step 106. In selecting the option to initiate a conference call, the business process server 102 can initiate a phone call with the communication system 110.

The communication system 110 can be any hardware, software, networks, or other components or systems used in enterprise communications. For example, the communication system 110 may include with Meeting Exchange® or Meeting Exchange® Express offered by Avaya® Inc., a private branch exchange, or other systems to complete communications. The communication system 110 includes a conference bridge 112. The conference bridge 112 is a system that allows conferencing between two or more parties. For example, the conference bridge 112 can establish a conference call between party 1 (108), which can be a communication endpoint, and party 2 (116), which can be a second communication endpoint. In embodiments, the conference bridge 112 also offers a set of commands or functions that allow the parties to manage the conference call.

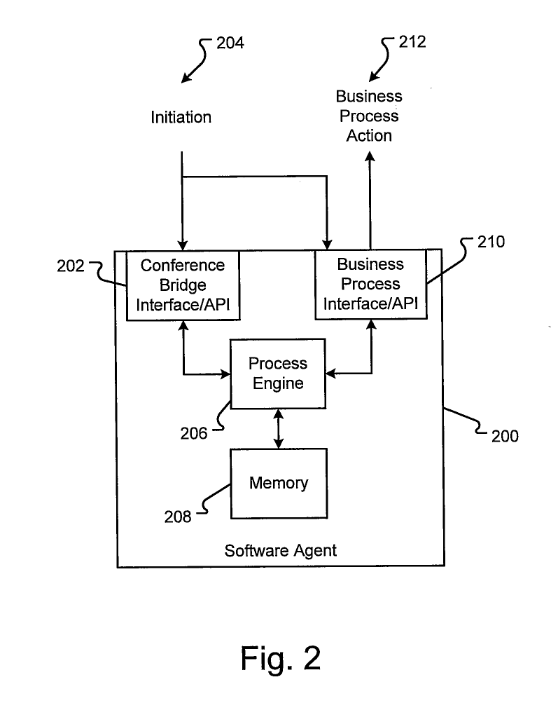

In embodiments, when the business process server 102 acts to create the conference call, a software agent 114 is initiated. The software agent 114 is a software application that can interface with the conference bridge 112 and the business process server 104. The software agent 114b can be a process executing on the conference bridge, executing on the communication system, or a separate stand-alone service or process 114a executing on a party computer or the business process server 102 that can interface with the conference bridge 112. Further description of the components and operations of the software agent 114 are described in conjunction with FIG. 2.

At some point in the conference call, the parties 108 and 116 determine some action to take with regard to the process step. The action 118 can be input into the software agent 114, which can communicate the action 118 back to the business process application 104. Interaction between the participants and the software agent 114 can be speech-based grammar and/or DTMF. In this way, the business process does not end with a conference call but, rather, any decision made in the conference call can be input back into the business process. To input the action 118 to the software agent 114, the software agent may authenticate the conference participant that is sending the action 118. The authentication may include checking to ensure that the participant has authority to send the action (one or a portion of the participants may have authority to act on the business process). The check can include identifying the phone where the input is coming from as a phone belonging to a participant with authority or the software agent 114 may complete an exchange of security or participant credentials with the participant. In embodiments, the software agent 114 may also convert a voice input into text that is readable by the business process application 104 or other participants. The readable text can be sent to other participants as an email that records the decision met and communicated to the software agent 114. The action may be communicated from the software agent 114 to the business process application 104 by a subscribe/notify asynchronous function between the business process application 104 and the software agent 114.

An embodiment of a software agent 200 is shown in FIG. 2. The software agent 200 can be the same or similar to software agent 114 as described in conjunction with FIG. 1. The components of the software agent 200 may function as software and/or hardware modules. A functional description is provided hereinafter. A conference bridge interface/API 202 is an interface to the conference bridge 112. The interface 202 allows the software agent 200 to interact and communicate with the conference bridge software and/or hardware. For example, the interface 202 may allow the software agent 200 to accept Dual-tone multi-frequency (DTMF) signals. The business process interface/API 210 similarly allows the software agent 200 to communicate with the business process application 104. For example, the interface 210 allows the software agent 200 to accept information about the process step 106 and to create the action 118 that is sent to the business process application 104.

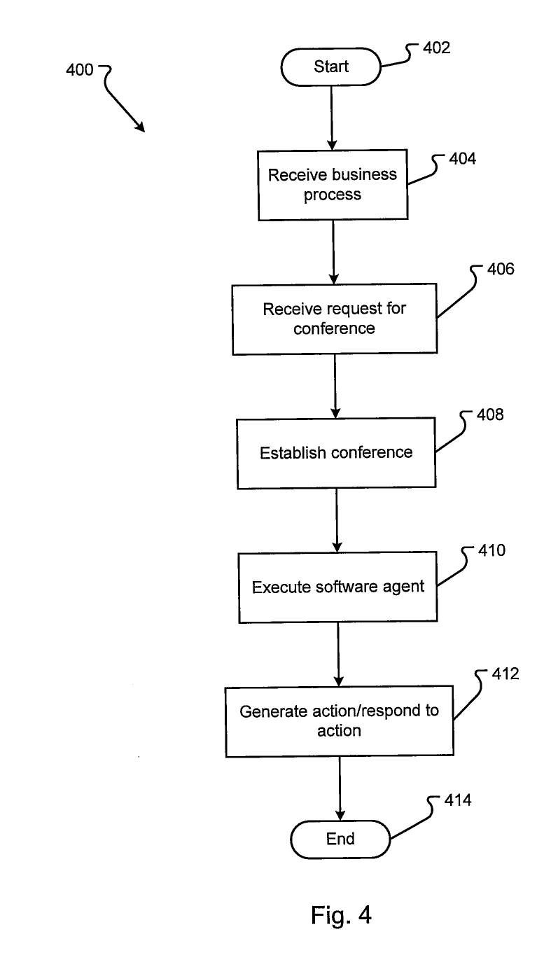

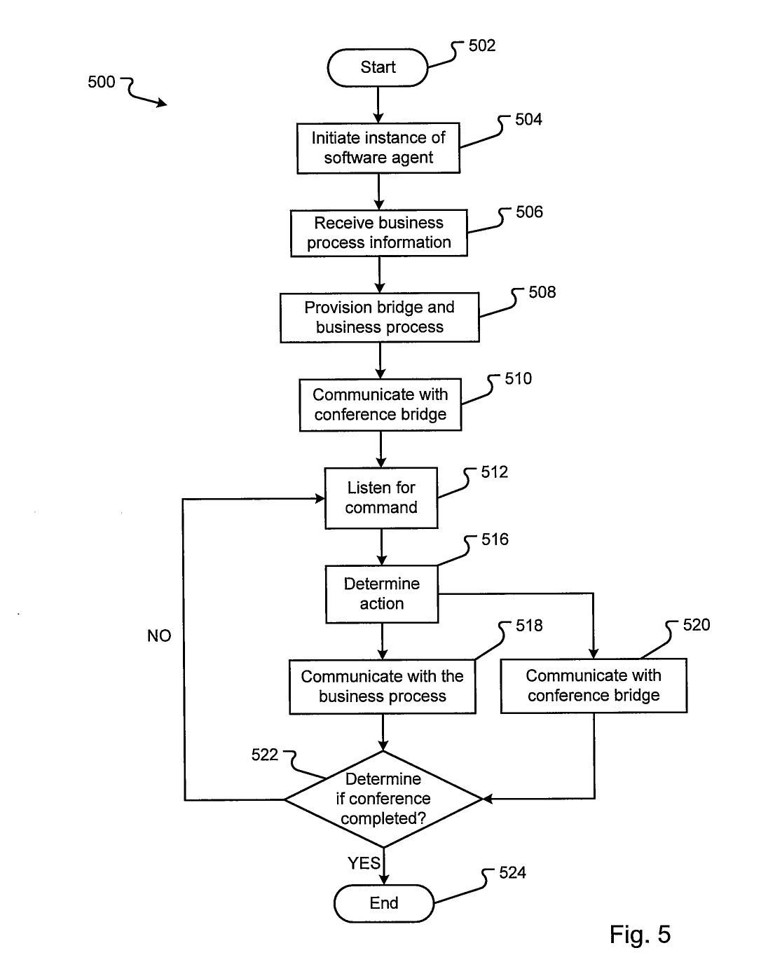

The process engine or “core” 206 receives the inputs, determines actions to conduct, and generates outputs. Some of these processes are explained hereinafter in conjunction with FIGS. 4 and 5. The process engine 206 can communicate with the conference bridge interface 202, the business process application interface 210, and a memory 208. The memory 208 can be any data storage as explained in conjunction with FIG. 7. The memory 208 executes to store information about the process step 106 and the one or more rules for the process engine 206 to apply to the inputs to create the appropriate action 118.

The software agent 200 can receive an initiation directive 204 to instantiate itself. The initiation directive 204 may be communicated from the business process server 104 or the communication system 110. Thus, where the initiation directive 204 originates depends on the type of conference call or the method in which the conference call was established. Further, the software agent 200 can communicate a business process action 212, which may be the same or similar to the action 118. The business process action 212 can be any input into the business process for the business process application 104 that continues or completes the business process.

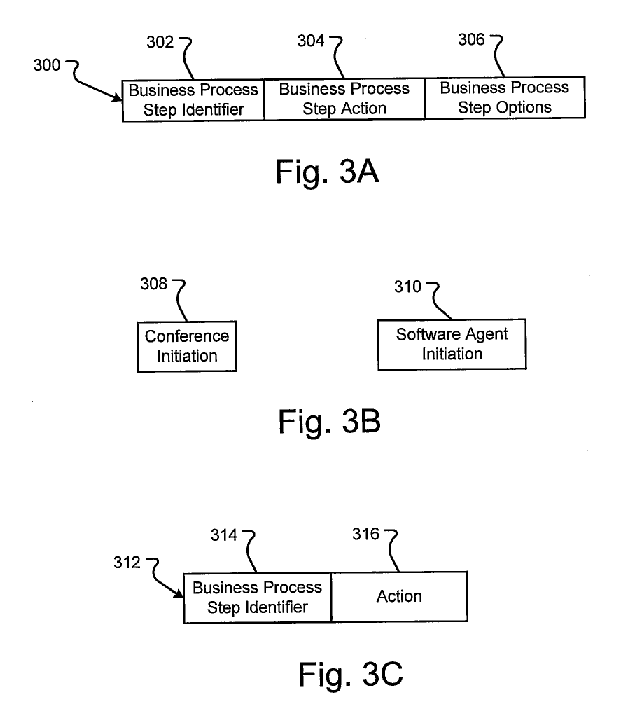

Embodiments of data structures embodying information stored, received, or sent with the systems and components as described in FIGS. 1-2 are shown in FIGS. 3A-3C. A data structure 300 embodying a business process step 300 is shown in FIG. 3A. The business process step 300 may be the same or similar to business process step 106. While the business process step 300 is shown with three data fields, it should be understood that the business process step 300 may have more or fewer data fields than those shown in FIG. 3A. Embodiments of the business process step 300 can include a business process step identifier field 302, a business process step action field 304, and/or a business process step options field 306.

The business process step identifier field 302 includes an identifier for the business process step. The identifier can include an identification of the business process that generated the business process step and/or identification for this step among the two or more steps involved in the business process. In embodiments, the business process step identifier 302 is a globally unique identifier (GUID).

The business process step action field 304 can include the one or more actions to be completed by the user. For example, the action 304 can be a request for approval of a purchase order. Further, the business process step action field 304 can include other information necessary for the user to complete the action. For example, the business process step action field 304 may include a description of the business process, what actions have already been completed, what actions still need to be completed, the author of the business process, etc. The action information 304 can be presented to the user on a computing system.

Any one business process step may be completed by one or more actions. As such, the business process step options field 306 can include a listing of the one or more options for the business process step. For example, a purchase order approval may be completed by denying the request, approving the request, requesting a conference to discuss the purchase order with another party, etc. Thus, the business process step options field 306 includes the options that the user can take in addressing the action. These options 306 may be presented to the user on a computer system.

Conference initiation data structure 308 and software agent initiation data structure 310, as shown in FIG. 3B, include at least two of the possible data packets created if the user decides to select a conference call in the options 306. A conference initiation data structure 308 includes the one or more commands required for the conference bridge 112 to begin a conference call. The conference initiation data structure 308 can include one or more data fields for directing the conference bridge to call one or more other parties with phone numbers provided in the conference initiation data structure 308. The software agent initiation data structure 310 includes the one or more commands or information required to instantiate an instance of a software agent 114 for the conference call. The software agent initiation data structure 310 may include the information in data structure 300 with the addition of new options for the business process step.

An embodiment of a data structure 312 that represents a possible action 118 generated by a software agent 114 is shown in FIG. 3C. The business process action 312 can include one or more fields. In an embodiment, the business process action 312 includes a business process step identifier 314, which may be the same or similar to the business process step identifier 302, and an action 316. The action field 316 can include the option or options selected from the business process step options 306 or selected or generated during the conference call. The action field 316 provides the information required by the business process application 104 to complete or continue the business process.

An embodiment of a method 400 for integrating a business process with a software agent is shown in FIG. 4. Generally, the method 400 begins with a start operation 402 and terminates with an end operation 414. While a general order for the steps of the method 400 are shown in FIG. 4, the method 400 can include more or fewer steps or arrange the order of the steps differently than those shown in FIG. 4. The method 400 can be executed as a set of computer-executable instructions executed by a computer system and encoded or stored on a computer readable medium. Hereinafter, the method 400 shall be explained with reference to the systems, components, modules, data structures, etc. described in conjunction with FIGS. 1-3C.

The user computing device receives a business process step 106 from a business process application 104 in step 404. The business process step 300 includes one or more options 306 to complete the action 304 received by the user. In embodiments, the user selects an option to conduct a conference call. The business process server 102 receives the request for the conference call in step 406. Thus, the business process server 102 then interacts with the communication system 110 to initiate the conference call.

The business process server 102 or the communication system 110 establishes the conference call by sending a conference initiation 308 to the conference bridge 112 in step 408. The conference bridge 112 may then execute to connect party 1 108 and at least party 2 118 in a conference call by dialing the parties' phone numbers. Either in conjunction with the establishment of the conference call or soon thereafter, the business process application 104 or communication system 110 recognizes the need for a software agent 114 because this conference call was generated from a business process. Thus, either the business process application 104 or communication system 110 sends an initiation 204, which can include a software agent initiation 310, to the conference bridge 112 to instantiate an instance of the software agent 114 in step 410.

The software agent 114 executes during the conference call in step 104. The execution of the software agent 114 is as described in conjunction with FIG. 5. Either during or at the termination of the conference call, the software agent 114 generates an action 118 or responds to the business process step 106 in step 412. In embodiments, the software agent 114 creates the action 312 and sends the action 312 to the business process application 104. The business process may either complete or continue based on the action 316 in the action response 312.

An embodiment of a method 500 for executing a software agent 114 during a conference call on a conference bridge, from the perspective of the software agent 114, is shown in FIG. 5. Generally, the method 500 begins with a start operation 502 and terminates with an end operation 524. While a general order for the steps of the method 500 are shown in FIG. 5, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, components, modules, data structures, etc. described in conjunction with FIGS. 1-3C.

The conference bridge 112 receives a software agent initiation 310 from the business process application 104. The initiate command 204 is then sent to instantiate an instance of a software agent 200 in step 504. After initiating, the software agent 200 then may interact with the business process application 104 to receive information about the business process step 106 in step 506. In alternative embodiments, party 1 108 forwards the information for the business process step 300 to the software agent 114 after the software agent 114 initiates. Any information received may be stored by the process engine 206 in memory 208 for future retrieval.

The software agent 114 may then provision the conference bridge 112 in step 508. To provision the conference bridge 112, the software agent 114 establishes the teleconference with the conference bridge interface 202. Here, the software agent 114 uses the information provided by the business process step to create the teleconference between the parties. With the conference bridge 112, the software agent 114 may dial into the conference call similar to another party or person. Thus, the software agent 114 acts as a third party. In other embodiments, the software agent 114 registers as a software process and provides inputs and outputs for the conference bridge 112. Similar software registration may be conducted with the business process application 104.

After provisioning, the software agent 200 can communicate with the conference bridge 112 with the conference bridge interface 202 in step 510. The communications provide an awareness to the parties involved in the conference that the software agent 200 is active. Then, the software agent 200 remains passive and listens for commands in step 512. The commands may be provided by one of the parties through a Voice Extensible Markup Language (XML) or a Media Server Markup Language (MSML) application. For example, a party may say: “Software Agent: Action: Approve Purchase Order.” Other commands are possible and envisioned. Commands may also be entered through one of the communication endpoints used by the parties. For example, a user can employ a speech-based input based on a predefined grammar and/or DMTF signaling to communicate with the software agent 200. Thus, the conference bridge 112 during provisioning can be directed by the software agent 200 to send certain DMTF signals to the conference bridge interface 202. The conference bridge interface 202 may then recognize these DMTF signals as commands. For example, to execute the same purchase order approval, the user may dial “*12,” which directs the next signal to the software agent 200, and then “*04,” which signals the software agent 200 to approve the purchase order. There may be other methods or means for commanding the software agent 200, for example, a party may use a computer to send a command to the software agent 200, such as by email, instant message, HTML or XML command from a website or social networking site.

The software agent 200 listens for commands on the conference bridge interface 202. If some communication is sent to the software agent 200, the conference bridge interface 202 sends the communication to the process engine 206, which determines if the command is an action in step 516. The process engine 206 can access information in the memory 208 to compare the received communication to known commands. The known commands may be the options 306 provided by the business process step 300, or commands provided in the instantiation of the software agent 200. The options may be created automatically by the business process step 300, a user may create the options, or the options may be a standard set of commands. Thus, the process engine 206 determines the grammar of the actions and compares the grammar to a list of known commands. If the comparison shows a command, the process engine 206 can generate a command or action for either the business process application 104 or the conference bridge 112.

Again, to input the action 118 to the software agent 114, the software agent may authenticate the conference participant that is sending the action 118. The authentication may include checking to ensure that the participant has authority to send the action. For example, only one of five participants may be able to act on the business process step. In embodiments, the participant with authority may be the person that originally received the business process step. The check can include identifying the phone from which the input is coming as a phone belonging to a participant with authority. In alternative embodiments, the software agent 114 may complete an exchange of security or other credentials with the participant. The credential exchange may be manual or automated through the participants' phone or computer.

If the command or action is for the business process application 104, the software agent 200 can send the command or action to the business process application 104 in step 518. Here, the process engine 206 forms the input for the business process application 104. For example, the command may be to approve the purchase order discussed in the teleconference. The command is sent to the business process interface 210 where the command is translated into a format, protocol, grammar, or language understandable by the business process application 104. The business process interface 210 can then send the command or action to the business process application 104. In embodiments, the software agent 114 may also convert a voice input into text that is readable by the business process application 104 or other participants. The readable text can be sent to other participants as an email that records the decision met and communicated to the software agent 114.

Likewise, if the command or action is for the conference bridge 112, the software agent 200 can send the command or action to the conference bridge 112 in step 520. Here, the process engine 206 forms the command for the conference bridge 112. A command to the conference bridge 112 can be a directive to change a setting for the conference or execute a function associated with the conference bridge 112. The command is sent to the conference bridge interface 202 where the command is translated into a format, protocol, grammar, or language understandable by the conference bridge 112. The conference bridge interface 202 can then send the command or action to the conference bridge 112.

The software agent 200 can then determine if the conference is completed. For example, the software agent 200 may listen or wait for a signal or indication that the conference is completed. The signal or indication can include the disconnection of all participants, a termination signal from the conference bridge 112, a command from a participant for the software agent 200 to stop executing, etc. If the conference has completed, the process 500 flows YES to end operation. The software agent 200 may continue processing actions and commands even after the participants in the teleconference have stopped the teleconference. If the conference has not completed, the process flows 500 NO back to the listen step 512 to await further commands.

FIG. 6 illustrates a block diagram of a computing environment 600 that may include the mobile device 104, the multimedia server 108, the set-top box 110, or other systems described herein for providing information about broadcast content. The system 600 includes one or more user computers 605, 610, and 615. The user computers 605, 610, and 615 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIXTM or UNIX-like operating systems. These user computers 605, 610, 615 may also have any of a variety of applications, including for example, database client and/or server applications, and web browser applications. Alternatively, the user computers 605, 610, and 615 may be any other electronic device, such as a thin-client computer, Internet-enabled mobile telephone, and/or personal digital assistant, capable of communicating via a network (e.g., the network 620 described below) and/or displaying and navigating web pages or other types of electronic documents. Although the exemplary system 600 is shown with three user computers, any number of user computers may be supported.

System 600 further includes a network 620. The network 620 can be any type of network familiar to those skilled in the art that can support data communications using any of a variety of commercially-available protocols, including without limitation TCP/IP, SNA, IPX, AppleTalk, and the like. Merely by way of example, the network 620 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 602.11 suite of protocols, the Bluetooth™ protocol known in the art, and/or any other wireless protocol); and/or any combination of these and/or other networks. The network 620 may be the same or similar to network 214.

The system may also include one or more server computers 625, 630. One server may be a web server 625, which may be used to process requests for web pages or other electronic documents from user computers 605, 610, and 620. The web server can be running an operating system including any of those discussed above, as well as any commercially-available server operating systems. The web server 625 can also run a variety of server applications, including HTTP servers, FTP servers, CGI servers, database servers, Java servers, and the like. In some instances, the web server 625 may publish operations available operations as one or more web services.

The system 600 may also include one or more file and or/application servers 630, which can, in addition to an operating system, include one or more applications accessible by a client running on one or more of the user computers 605, 610, 615. The server(s) 630 may be one or more general purpose computers capable of executing programs or scripts in response to the user computers 605, 610 and 615. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 630 may also include database servers, including without limitation those commercially available from Oracle, Microsoft, Sybase™, IBM™ and the like, which can process requests from database clients running on a user computer 605.

The web pages created by the web application server 630 may be forwarded to a user computer 605 via a web server 625. Similarly, the web server 625 may be able to receive web page requests, web services invocations, and/or input data from a user computer 605 and can forward the web page requests and/or input data to the web application server 630. In further embodiments, the server 630 may function as a file server. Although, for ease of description, FIG. 6 illustrates a separate web server 625 and file/application server 630, those skilled in the art will recognize that the functions described with respect to servers 625, 630 may be performed by a single server and/or a plurality of specialized servers, depending on implementation-specific needs and parameters. The computer systems 605, 610, and 615, file server 625 and/or application server 630 may function as multimedia servers 202, ancillary servers 216, 218, 220, and/or 222, or other systems described herein.

The system 600 may also include a database 635, which may be the same or similar to database 230, 302, or 306. The database 635 may reside in a variety of locations. By way of example, database 635 may reside on a storage medium local to (and/or resident in) one or more of the computers 605, 610, 615, 625, 630. Alternatively, it may be remote from any or all of the computers 605, 610, 615, 625, 630, and in communication (e.g., via the network 620) with one or more of these. In a particular set of embodiments, the database 635 may reside in a storage-area network (“SAN”) familiar to those skilled in the art. Similarly, any necessary files for performing the functions attributed to the computers 605, 610, 615, 625, 630 may be stored locally on the respective computer and/or remotely, as appropriate. In one set of embodiments, the database 635 may be a relational database, such as Oracle 10i™, that is adapted to store, update, and retrieve data in response to SQL-formatted commands.

FIG. 7 illustrates one embodiment of a computer system 700 upon which multimedia server 108, the mobile device 104, the set-top box, or other systems described herein may be deployed or executed. The computer system 700 is shown comprising hardware elements that may be electrically coupled via a bus 755. The hardware elements may include one or more central processing units (CPUs) 705; one or more input devices 710 (e.g., a mouse, a keyboard, etc.); and one or more output devices 715 (e.g., a display device, a printer, etc.). The computer system 700 may also include one or more storage device 720. By way of example, storage device(s) 720 may be disk drives, optical storage devices, solid-state storage devices such as a random access memory (“RAM”) and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735, which can include a DSP, a special-purpose processor, and/or the like

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with the network 720 and/or any other computer described above with respect to the system 700. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 700 may also comprise software elements, shown as being currently located within a working memory 740, including an operating system 745 and/or other code 750, such as program code implementing the ancillary server 300. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A computer program product including computer executable instructions stored onto a computer readable medium which, when executed by a processor of a computer, causes the computer to perform a method for associating a teleconference with a business process, comprising:
instructions to receive a business process step for a first user;
in response to receiving the business process step, instructions for receiving a request for a teleconference between the first user and a second user;
instructions to establish the teleconference on a conference bridge;
in response to establishing the teleconference, instructions to execute a software agent; and
instructions to generate a response to the business process step with the software agent, wherein the software agent communicates the response to the business process step.

2. The computer program product as defined in claim 1, wherein the software agent is executed on the conference bridge.

3. The computer program product as defined in claim 1, wherein a business process server generates the business process step and receives the response to the business process step.

4. The method as defined in claim 3, wherein the business process step is associated with a business process managed by the business process server, and wherein the business process comprises two or more business process steps.

5. The method as defined in claim 1, wherein the first user selects the teleconference as an option associated with the business process step.

6. The method as defined in claim 1, wherein the software agent generates the response to the business process step in response to a command provided by the first user or the second user during the teleconference.

7. A communication system comprising:
a conference bridge operable to conduct a teleconference between a first user and a second user in response to a business process step;
a processor operable to read and operable to execute two or more computer executable modules;
a memory in communication with the processor, the memory operable to store and operable to send the two or more computer executable modules to the processor; and
wherein the processor executes a computer executable module comprising a software agent in communication with the conference bridge, the software agent comprising:
a conference bridge interface operable to communication with the conference bridge;
a business process interface operable to communicate with a business process server, wherein the business process server generates the business process step; and
a process engine in communication with the conference bridge interface and the business process interface, the process engine operable to receive inputs from the conference bridge interface and the business process interface, the process engine operable to generate a response to the business process step in response to an input, and the process engine provides the response to the business process interface to send to the business process server.

8. The communication system as defined in claim 7, wherein the inputs from the conference bridge interface include voice commands that direct the process engine to execute functions associated with the business process step.

9. The communication system as defined in claim 8, further comprising a memory to store functions and data associated with the functions, wherein the memory stores one of voice XML and MSML data, and wherein the process engine compares the voice command with one of the voice XML data and the MSML data to determine the function to execute.

10. The communication system as defined in claim 7, wherein the inputs from the conference bridge interface include one of a speech-based input based on a predefined grammar and DMTF commands.

11. The communication system as defined in claim 7, further comprising a business process server in communication with the conference bridge, the business process server initiating the software agent in response to an option received with the business process step, the business process server operable to receive the response to the business process step from the business process interface.

12. The communication system as defined in claim 11, wherein the business process interface translates communications from the process engine for the business process server.

13. A method for associating a business process step with a teleconference, the method comprising:
a processor initiating an instance of a software agent, the software agent associated with the business process and the teleconference;
the software agent receiving business process information associated with the business process step;
the software agent provisioning the teleconference on a conference bridge;
the software agent communicating with the conference bridge during the teleconference;
the software agent listening for a command during the teleconference;
the software agent receiving a command during the teleconference; and
in response to receiving the command, the software agent communicating with the business process about the business process step.

14. The method as defined in claim 13, wherein the processor receives a command from a business process server to initiate the software agent.

15. The method as defined in claim 13, wherein the business process information includes a business process step data structure, the business process step data structure comprising:
a business process step identifier;
a business process step action; and
an option to respond to the business process step.

16. The method as defined in claim 13, wherein the software agent interacts with the conference bridge as another party to the teleconference.

17. The method as defined in claim 13, wherein the command is a voice XML application command.

18. The method as defined in claim 13, wherein the command is one of a speech-based input based on a predefined grammar and DMTF commands a DMTF signal.

19. The method as defined in claim 13, wherein the software agent communicates an action for the business process step to the business process.

20. The method as defined in claim 19, wherein the action comprises:
a business process step identifier; and
an action for the business process.
